(19) United States
(12) Patent Application Publication
(10) Pub. No.: US 2016/0140649 A1
(43) Pub. Date: May 19, 2016

(54) Method and Apparatus for Automated Rental Key Dispensal and Return

(71) Applicant: Ford Global Technologies, LLC, Dearborn, MI (US)

(72) Inventors: Robert Bruce Kleve, Ann Arbor, MI (US); Christian Krozal, South Lyon, MI (US); David Randolph Roberts, Dearborn, MI (US)

(21) Appl. No.: 14/541,522

(22) Filed: Nov. 14, 2014

(51) Int. Cl. G06Q 30/06; G08G 1/01

(52) U.S. Cl. CPC G06Q 30/0645; G08G 1/01

(57) ABSTRACT

A system includes a processor configured to receive rental return information. The system is also configured to verify deposit of a key fob. Further, the system is configured to connect to a device containing vehicle usage information relating to a rental period. The system is additionally configured to gather vehicle usage information from the connected device. The system is also configured to verify a vehicle presence in a rental parking lot and terminate a vehicle rental.

### TECHNICAL FIELD

The illustrative embodiments generally relate to a method and apparatus for automated rental key dispersal and return.

### BACKGROUND

In an age of on-demand technology, people tire of waiting any amount of time to process a transaction. Ordering of products can be done instantly online, with same-day delivery sometimes available. Customers can act as their own check-out agents at stores. When checking in at an airport, lines can be avoided by use of digital check-in terminals. In many aspects of life, and especially when it comes to travel, weary customers have very little tolerance for delay.

To address this, to some extent, some rental car companies provide a self-service kiosk that allows customers to avoid the lines at the counter. Generally, a customer presents a license or passport, verifies identity with a PIN and a credit card, and receives a key in response.

In another method for managing vehicle check in at an automotive service center, the method may include connecting a device to the diagnostic port of an unknown vehicle and, without user input to the device, automatically downloading vehicle identification data and odometer data from the vehicle, and transferring the vehicle identification data and odometer data from the device to a work station at the service center. The work station may include a database that programmatically populates with the vehicle identification data and odometer data. The work station may retrieve information based on one or both of the vehicle identification data and the odometer; and display the retrieved data on one or both of a computer and a paper printout.

### SUMMARY

In a first illustrative embodiment, a system includes a processor configured to receive rental return information. The system is also configured to verify deposit of a key fob. Further, the system is configured to connect to a device containing vehicle usage information relating to a rental period. The system is additionally configured to gather vehicle usage information from the connected device. The system is also configured to verify a vehicle presence in a rental parking lot and terminate a vehicle rental.

In a second illustrative embodiment, a system includes a processor configured to receive rental identification information from a user mobile device. The processor is also configured to verify the received rental information and dispense a vehicle activation device in accordance with the received information.

In a third illustrative embodiment, a computer-implemented method includes receiving rental identification information from a user mobile device. The method also includes verifying the received rental information, using a kiosk-based processor and dispensing a vehicle activation device in accordance with the received information.

### BRIEF DESCRIPTION OF THE DRAWINGS

FIG. 1 shows an illustrative vehicle computing system;

FIG. 2 shows an illustrative example of a wireless key system;

FIG. 3 shows an illustrative example of a wireless key initial setup process;

FIG. 4 shows an illustrative example of a wireless key owner setup process;

FIG. 5 shows an illustrative example of a wireless key delivery process;

FIG. 6 shows an illustrative example of a wireless key usage process;

FIGS. 7A and 7B show illustrative examples of wireless key termination processes;

FIGS. 8A-8D show an illustrative example of a vehicle return process; and

FIGS. 9A-9D show an illustrative example of a vehicle rental process.

FIG. 10 shows an illustrative example of a kiosk rental begin-request process;

FIG. 11A shows an illustrative example of a verification process;

FIG. 11B shows a second illustrative example of a verification process; and

FIG. 12 shows an illustrative example of a kiosk rental end-request process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

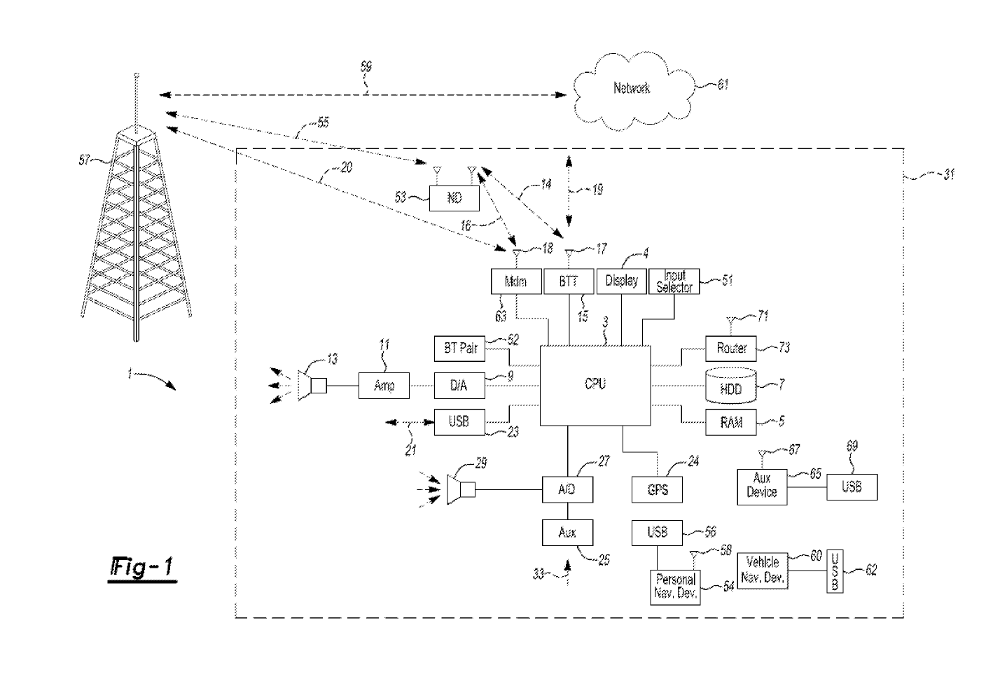

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11 g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing that portion of the process, since the wireless device would not “send and receive” information with itself. One of ordinary skill in the art will understand when it is inappropriate to apply a particular computing system to a given solution.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

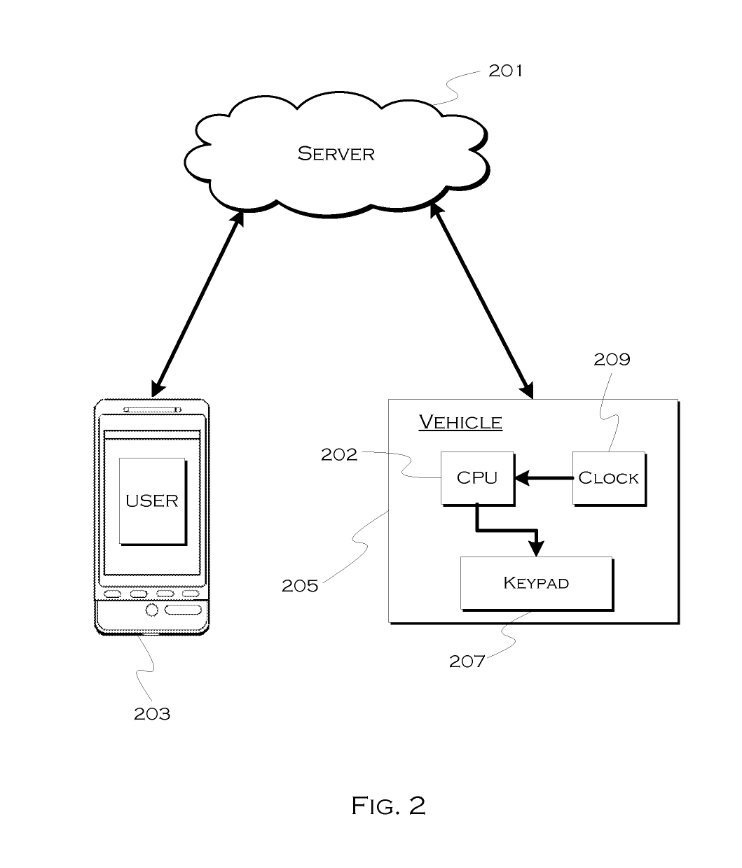

FIG. 2 shows an illustrative example of a wireless key system. The wireless key system provides an alternative to delivering physical keys to a user for use with the vehicle. Additionally, in at least one embodiment, control of physical key usability is enabled, so that keys can be left in, for example, rental vehicles, without fear of the vehicle being stolen through use of the keys.

In this illustrative example, a cloud server 201 is capable of controlling accounts for various vehicles 205. For example, if a fleet had a number of vehicles with the capabilities described herein, the server could associate all those vehicles with a fleet account. The vehicles, in this example, also include a keypad (for vehicle access) and a clock to track vehicle usage and rental start/end times. In some examples the cloud server may be a service provider engaged by the rental owner, or a service provided by the owner, in other examples for smaller fleets, the function of the cloud server may even be performed by the owner's phone.

The accounts can also communicate with any number of users 203. Through an internet connection or app on a phone, the users can access the fleet account to request vehicles. In another embodiment, if someone was borrowing a friend's car, for example, the borrower could access a lender account to request access. Information relating to the use of the vehicle, including access codes and start codes, can be delivered from the cloud server to the user's wireless device 203.

Using the delivered codes, which can be delivered to both the wireless device and the vehicle, for confirmation purposes, the user can access the vehicle through the keypad, and then enable the vehicle using a wireless start code, such as a rolling code.

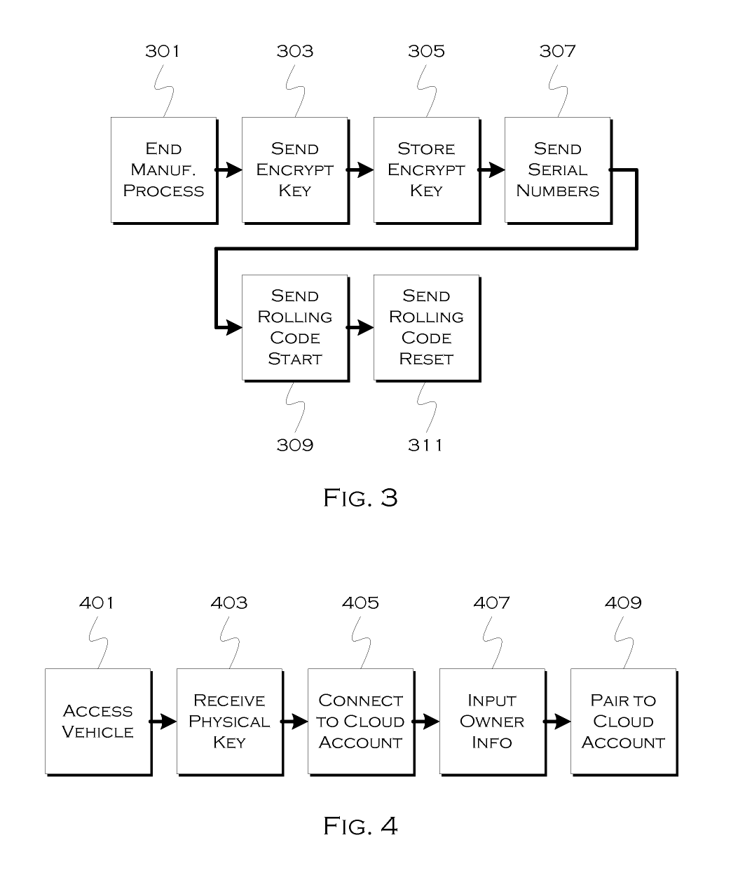

FIG. 3 shows an illustrative example of a wireless key initial setup process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a vehicle is initialized during the manufacturing process 301. This occurs before the vehicle is ever sold or owned, and allows an OEM to control setup of the initial vehicle control. This also means that the OEM has the information needed to perform resets and other control functions as needed.

During this process, an encryption key for the vehicle is sent to the OEM server, which handles vehicle accounts, and stored with respect to a remote vehicle account 303. The encryption key is also stored in the vehicle hardware 305. Since both sides then have the key, keyed encryption can be used for communication between the two ends of the system. This is useful when sending keypad codes, temporary user data, rolling ID codes and any other communication between the vehicle and the remote server.

In this illustrative example, several other pieces of information are provided to the cloud server. A vehicle computing system serial number or other identifier can be provided 307. This can be used as a means of secondary authentication in messages, as well as used to identify a receiving system. A rolling code start value 309 and rolling code reset values 311 can also be provided. Rolling codes will change whenever used (or at intervals) so that obtaining a single code value has almost no long-term use, or at least very limited use. This prevents renters from returning to the vehicle and using an old code, and helps prevent theft of a vehicle by theft of a code.

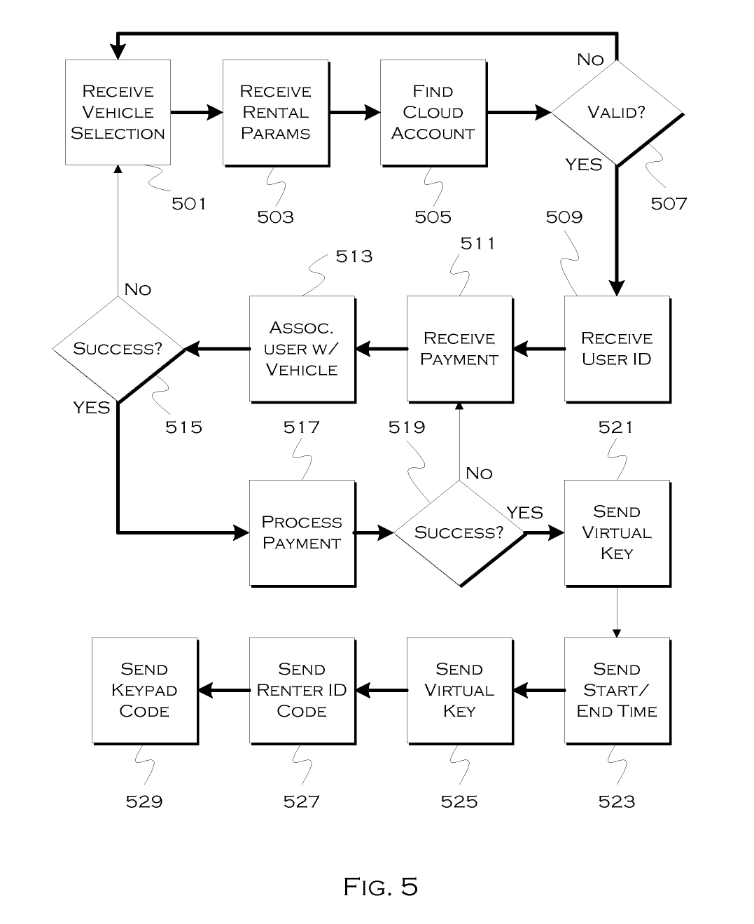

FIG. 4 shows an illustrative example of a wireless key owner setup process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Once the vehicle has been initialized by the manufacturer during manufacture, the vehicle may still have further setup to link the vehicle to a specific owner account. As previously noted, this can be useful for fleet management, and can be additionally useful for an individual who wishes to loan out a car, but doesn't want to leave the keys in the car (encouraging theft).

In this illustrative example, the new owner of the vehicle can access the vehicle 401, using a fixed entry code (the general entry code) or a physical key, or some other designation that represents that this accessing owner is the permanent owner of the vehicle (as opposed to a temporary user). In this example, the process receives entry of the physical key 403, and based on the presence of the key, accesses a cloud based account to be associated with the vehicle 405.

The owner information can then be input, using, for example, a vehicle based HMI. If there is not a sufficient HMI in the vehicle, an application on a mobile device can be used in conjunction with the initialization process, or a website could be used after initialization was started with the physical key. The owner information is input 407 and various identifying vehicle information is shared between the vehicle and the cloud, for example Vehicle Identification Number (VIN, serial numbers of various modules on the vehicle or other unique identifying characteristics. At this point the vehicle is paired with an owner related cloud account. Each vehicle can have an individual account, and/or multiple vehicles can be associated with a single account (for fleet management, for example).

In this manner, any number of fleet vehicles (such as in a rental fleet) can be associated with a user account. Rentals can be processed through the user account, with virtual vehicle keys being delivered to renters for limited access to the specific vehicles.

FIG. 5 shows an illustrative example of a wireless key delivery process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, a user rents a vehicle from a fleet managed with virtual wireless keys. The user can use an application or other interface to process the selection, payment and rental of the vehicle, and then the keys and rental handling can be performed autonomously. This way, vehicles can be located anywhere and a user can still easily access the vehicle. Even if the vehicles are all in a rental lot, however, rental lines can be skipped, and rental personnel can be kept to a minimum. A similar process could be used for borrowing a vehicle, or even for an individual renting their vehicle for temporary use. Thus, this process can facilitate vehicle sharing programs and schema as well.

In this example, a user accesses an inventory of vehicles and selects a specific vehicle or vehicle class 501. If a vehicle class is selected, the process may then select a known vehicle fitting within the vehicle class, for processing the rental. In addition to the vehicle selection, rental parameters (typically date(s) and time(s)) can also be received 503. These parameters can be used when the rental is processed, and also to check vehicle availability.

The process can then access a cloud account 505 having one or more vehicles associated therewith. For example, without limitation, the rental company may have a cloud account with all of the vehicles owned by that company. Using the cloud account, the process can check if the selected vehicle is available that fits the rental parameters.

Since virtual key handling can be controlled through the cloud account, the cloud account can also act as a scheduler, since it knows when a virtual key for a given vehicle will expire. While some grace period may be built into the rental period, the process can generally know when a given vehicle will be available. Also, since a number of vehicles may be accessible through the same account, the process can check for other vehicles if a given vehicle is not available at the specified time (i.e., the renter arrives and the vehicle has not yet been returned). Dynamic reassignment of vehicles can be easily facilitated through the application. Also, if a user wants to change vehicle class, the system can easily disable the old virtual key and send a new virtual key for a different vehicle.

Once a vehicle selection has been verified as available, the process may receive a user identification 509. This may include, among other things, an identifier as to where a virtual key is to be sent. This can include, but is not limited to, an email address, phone number, text number, application ID, etc. The process can also receive payment for the rental, if payment is due in advance 511. Payment receipt can also be delayed, if desired, until some moment before the virtual key is delivered (allowing for cancellations, etc.).

The process, once any needed information has been received, can then associate the user with the vehicle 513. This can include saving a rental date for the user, and setting the vehicle as “rented” during the specified time. Virtual keys for the rental period can also be setup at this time. If the association is successful 515, and virtual keys can be established, the process can proceed to receive the payment from the specified source 517 (if desired).

If the payment was successful 519, the process can send the information for the virtual key, even if the rental period is days, weeks or months away 521. This is possible because the virtual key has a temporally related start and end date. This means that the key will not function outside the specified time period (with certain exceptions), and is generally useless until the rental period arrives. While the key may be non-functional, the user may still be happy to receive the key in advance.

The system may allow renters to change the rental dates, and to facilitate this and to prevent misuse or fraud in situations without Cellular or Wifi connectivity, the system may use an incrementing Renter Number and Event or Command Number that is included in the encrypted packet and the vehicle system then only accepts a Renter Number or Command Number that is higher than before. In this way the system can make changes to a renter's virtual key by sending a new one to the renter's phone with a higher Renter Number. If the reservation is for a date farther in the future, the Renter number sent to the user may be much higher to allow for other renters to reserve the car in the timer period before then future rental start. The command number may also be incremented upon each connection to the vehicle to increase the security. The key may also include a refreshing of the next valid entry codes for the vehicle to store for future renters so as to keep the vehicle with a supply of valid entry codes.

Also, since the key is virtual, if the reservation is cancelled or changed, the process can simply disable the key, so that the key never functions at all. This may be done by forcing the renter to cancel or change the reservation by connecting his phone to the cloud account so that virtual key stored on the renters phone may be overwritten by a terminated key or a changed key. In this example, the key consists of a key code to enter the vehicle, and a rolling code to activate the vehicle. By disabling one or both of these keys, the user will be prevented from using the vehicle on the specified times. Outside of those times, the key will generally be designated as non-functional.

The start and end times can be sent to the vehicle as well 523, along with a copy of the virtual key 525. The vehicle can then store the key and the enablement times, and, when the time approaches, the vehicle can enable the key. Thus, if the vehicle is out of communication range with the remote server for some reason, the user is not prevented from entering and using the vehicle.

In conjunction with this information, a vehicle entry code 527 and a vehicle start code 529 can both be sent to the vehicle and the user. Both can be temporary codes, both enabled for finite periods of time. This prevents early or late use of the codes, stopping the user from accessing the vehicle outside the rental parameters. The entry code can be used to access the vehicle interior, through a doorpad, for example, and the start code could be entered in the vehicle (on an HMI or other device) to enable the vehicle to start. Limited power can be provided to the HMI when a valid door code is used, for the purpose of entering the secondary code. Codes using various vehicle buttons can also be used (a series of radio button presses, for example) in systems without sufficient HMIs.

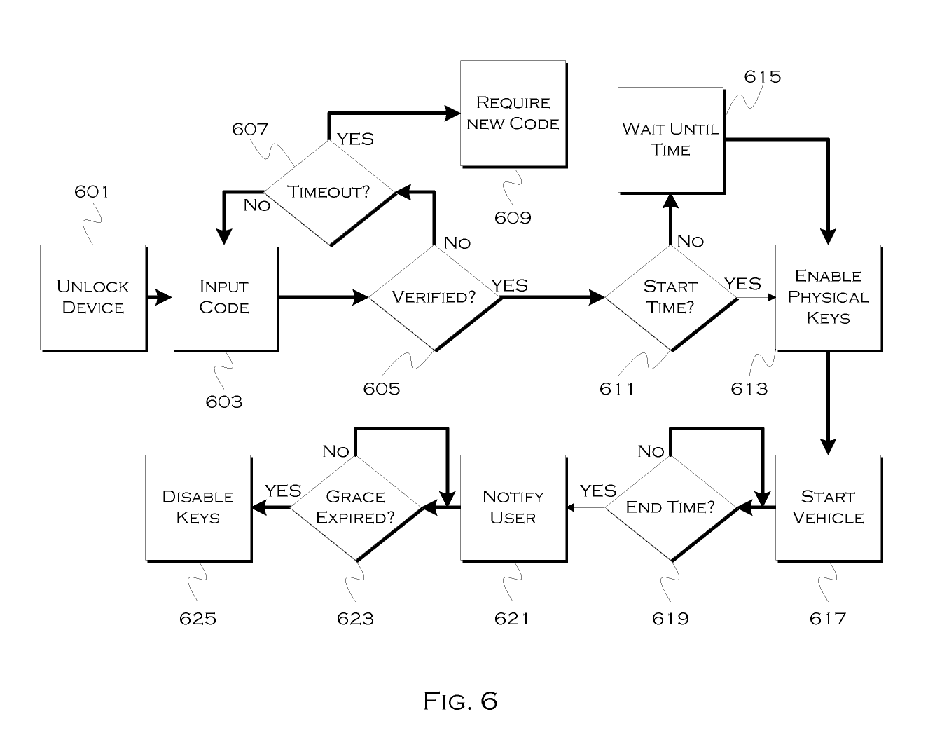

FIG. 6 shows an illustrative example of a wireless key usage process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

This is an exemplary process for access and use of the vehicle utilizing a virtual key. While a “standard” key may also be used in conjunction with this embodiment, the virtual key is used to access the vehicle during the rental period initially, and for vehicle startup in the absence of the physical key. The virtual key consists of two codes, in this embodiment, an access code for the vehicle and a startup code, and thus serves the same functions as a physical key would.

In this illustrative embodiment, the user uses the virtual key code to unlock the vehicle 601. In this example, the code is entered on the vehicle door, on a keypad, but other suitable methods of entry may also be used (wireless access through a connection to the phone, for example). Biometric ID could also be used, if the user scanned in a fingerprint on rental and the vehicle was equipped with biometric sensors. The same is true for the code to start the vehicle. In fact, in the biometric case, the rental company could be assured that the renting user was the person accessing the vehicle.

Once the code has been input into the door, and the vehicle is unlocked, the user enters a second code into the vehicle in order to start the vehicle 603. This is the renter ID code, and corresponds to a rolling code enabled for the rental period. In this example, the renter ID code can be used in place of a physical key, but the physical key can also be used.

If the code is not verified 605, the process checks to see if a timeout has occurred 607. Timeout, in this sense, includes exceeding a number of code entry attempts. If the timeout occurs, then the system assumes that someone is attempting to invalidly access the vehicle, and a new code can be requested 609 and sent to the user. If the person attempting to access the vehicle is anyone other than the authorized user, they presumably will not receive the new code, and thus will still not be able to start the vehicle.

Once the correct code has been entered, the process can check to see if the code is within its valid time period 611. Since the code is valid only after a particular start time, the user may not be able to use the code to access the vehicle until the start time arrives. In such a case, the process will wait until the start time has passed 615 before allowing the vehicle to activate.

In another example, if the user is a few hours early, but no one else is scheduled to use the vehicle in the intervening time period, the process may enable the code early. Since the process is aware of the code, it can validate the code as authentic, and then apply a new start time based on the fact that no one else needs to use the vehicle. New start time information can be recorded for billing purposes if desired.

In some instances, physical keys may be left in the vehicle as well. These keys can correspond to literal keys, or radio frequency (RF) keys that enable a push button start. In either event, these keys may be disabled unless a valid unlock and/or rolling ID code has been entered. In this example, both codes are entered before the physical key is enabled 613, but in other instances, only one code may be needed to enable the physical keys. For example, the user could enter a temporarily usable door code, during a valid time period, and have the physical keys immediately enabled.

Also, in this example, the vehicle is started 617. This can assist a user who can't find the keys. Or, if the previous user inadvertently left with the physical keys, the rolling code can still be used to start the vehicle, so the user isn't without access to the vehicle.

The rolling code and or physical keys continue to work for the vehicle until a rental end time arrives 619. The end time signifies the end of the rental contract, and the time at which the vehicle is to be returned or parked for use by another user.

Once the end time arrives, the process may notify the user 621, so the user knows that the next time the vehicle is turned off, the keys will cease to work. Exceptions to this policy can, of course, be made. For example, in this embodiment, a grace period will continue to run 623, presumably allowing the user to get the vehicle to a designated location. In other instances, a single stop at a location corresponding to a fuel station may be allowed, so the user can fill up the tank. Once the grace period expires, if desired, both the physical and virtual keys can be disabled. This will not necessarily shut down the vehicle, it just prevents the vehicle from being restarted (unless automatic shutdown is desired).

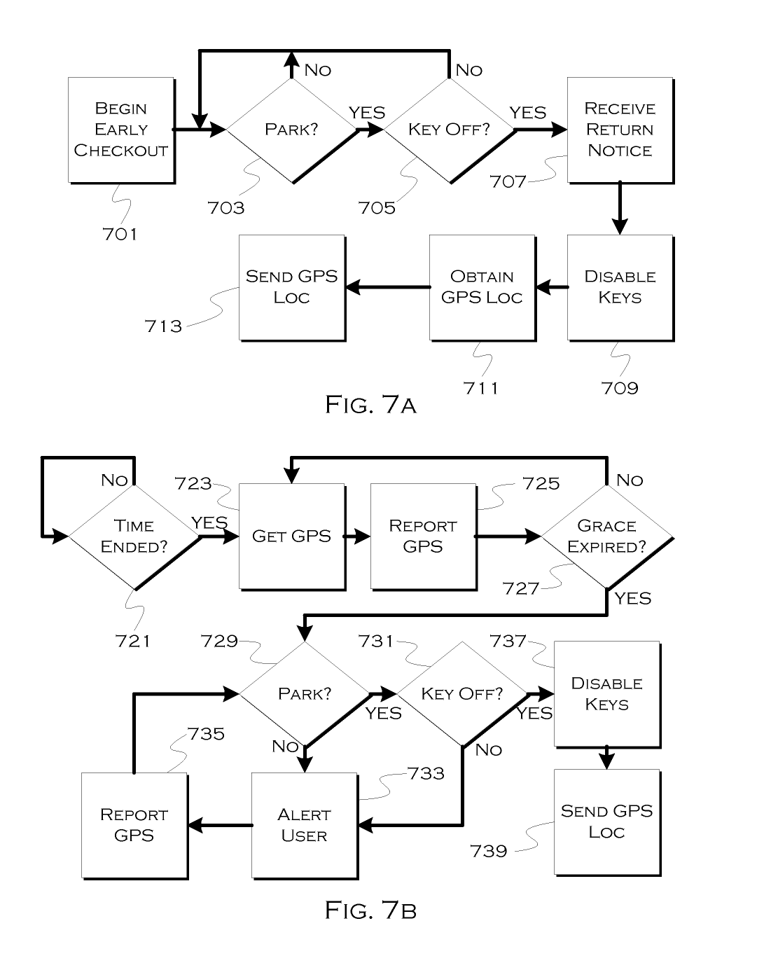

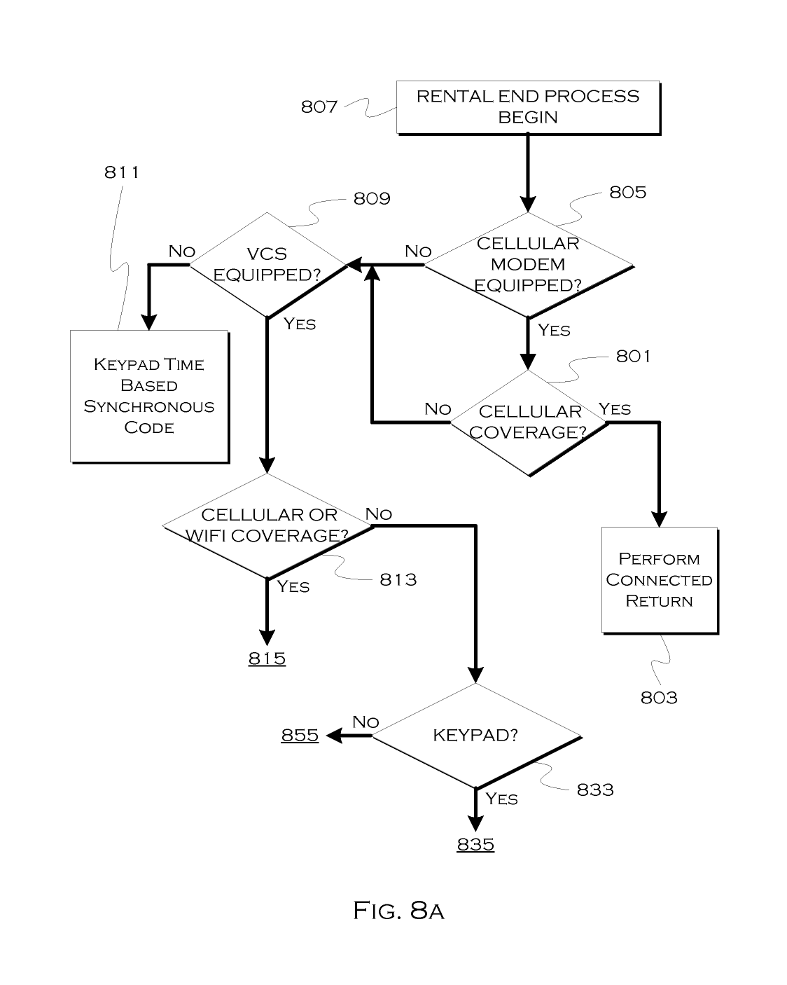

FIGS. 7A and 7B show illustrative examples of wireless key termination processes. With respect to the illustrative embodiments described in these figures, it is noted that a general purpose processor may be temporarily enabled as a special purpose processor for the purpose of executing some or all of the exemplary methods shown herein. When executing code providing instructions to perform some or all steps of the methods, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

FIG. 7A shows an example of a “standard” return process. In this illustrative embodiment, the renter returns the car, as agreed upon, within the requisite period of time. The renter may use an app or a vehicle interface, for example, to initiate a check-out process for returning the vehicle 701.

In order to ensure that safety is maintained, the process may check to see if the vehicle is in park 703 and off 705 before the checkout begins. This also helps prevent the user from using the vehicle after the checkout process has completed (preventing checkout, for example, when the user is still miles from a destination, but has run out of agreed upon time). In addition this provides a measure of theft protection while the vehicle is parked between rental periods Once the checkout process is completed, the vehicle key will be disabled, as will the virtual key. The door key may also be disabled, or may remain active for some period of time, in case the user leaves an item in the vehicle. After a suitable time period, the door key may also be disabled.

Once the vehicle has been parked and powered off, the process receives a return notice from the remote server, verifying the return 707. At this point, the keys can be disabled 709 and the user can be notified that the vehicle can no longer be used.

Also, at this point, the process can take a GPS location of the vehicle (or a phone, running an app) to locate where the vehicle has been left 711. This could be particularly useful in the case where the vehicle is not left in a rental lot or other known location. The GPS location is then sent to the account owner 713, so the account owner can locate the vehicle. This location could also be sent to the next renter, so that renter can also locate the vehicle.

FIG. 7B shows an illustrative example of a rental end period where the renter does not reach an intended destination by the time the rental period expires. In this illustrative embodiment, the renter is either traveling in the vehicle, or has the vehicle located at a point where the vehicle was not intended to be left. In the latter case, if desired, the vehicle keys can simply be disabled, or the grace period can still be provided. In another embodiment, the renter could be warned and a limited time table could be set for returning the vehicle to a specified locale.

In this illustrative example, the process obtains and reports a vehicle GPS position 723, 725. This can be used to augment the grace period 727, if desired, for example, by extending the grace period if the vehicle is close to, or traveling towards, an intended destination. As long as the grace period continues 727, the process continues to report the vehicle GPS location. The grace period could also be prematurely ended if the vehicle strayed too far from a geographic region (such as a route headed to, or generally headed to, an intended destination).

Once the grace period has ended, the process checks to see if the vehicle is in a park state 729. If the vehicle is in park, the process can also check to see if the ignition is in an off state 731. If the park state and off state are not both present, the process can alert the user that a grace period has expired 733 and request that the user proceed to vehicle return as quickly as possible. The user may also be notified, for example, that the keys will soon be disabled. Actual conditions for key disabling may be provided or not, as desired. The GPS location of the vehicle can also be reported 735 for tracking purposes.

Once the vehicle is in park, and the key has been turned off (ignition off), the process can proceed to disable the keys 737. This can include, as above, some or all of the virtual key elements and/or the physical key. The process can also send the GPS location of the vehicle 739 to the rental company for tracking, retrieval and next renter use.

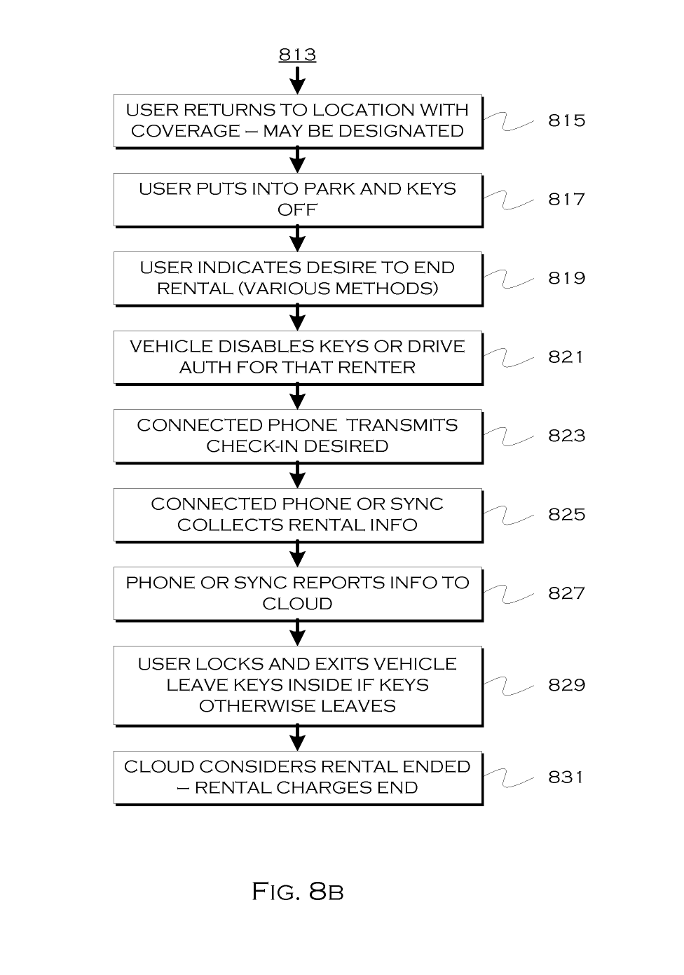

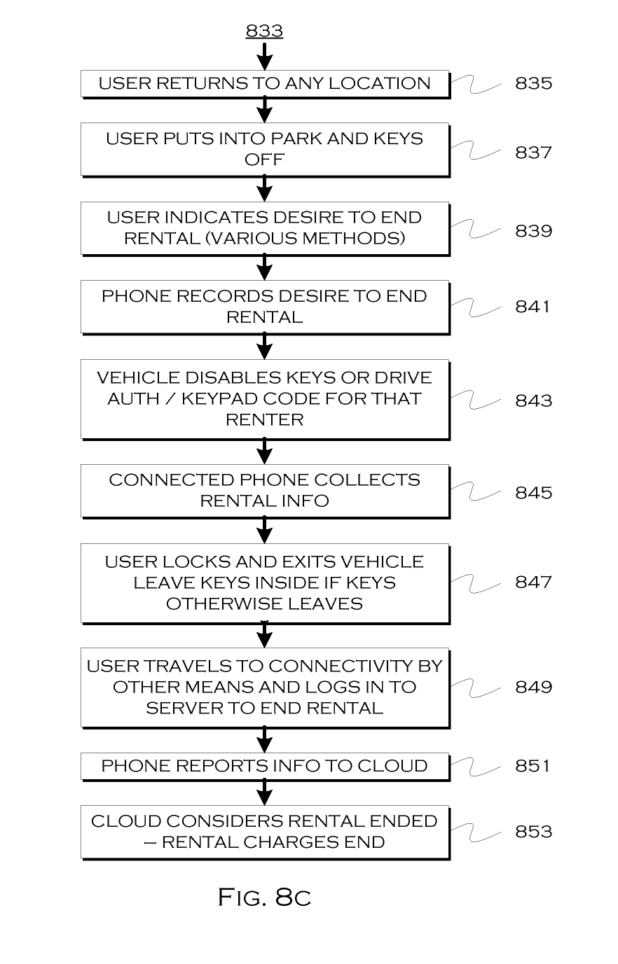

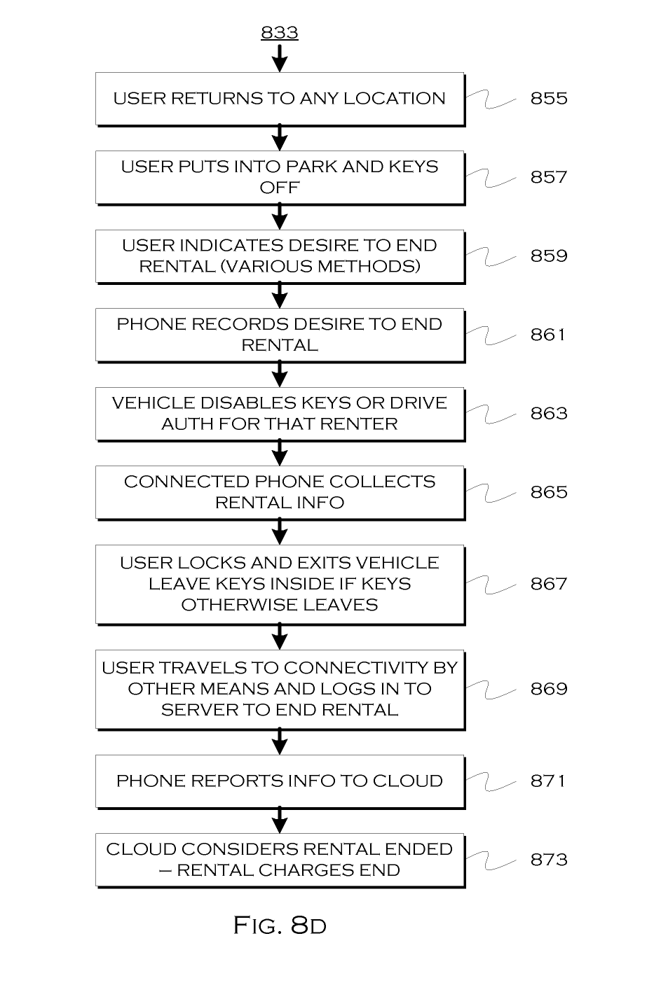

FIGS. 8A-8D show an illustrative example of a vehicle return process. With respect to the illustrative embodiments described in these figures, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the user decides to begin a rental end process 807. The process checks to see if a cellular modem is provided with the vehicle 805. If a cellular modem is provided, and if cellular coverage exists 801, the process will perform a return process for a connected vehicle 803, such as that shown in FIG. 7A, for example. Since the vehicle is connected to the cloud via a vehicle-based modem, check-out and return handling is made easy by direct communication between the vehicle and the cloud. Any temporary keys can be disabled, PINs can be disabled and/or reset, and a vehicle location can be logged via the cloud for a next renter.

This is a common scenario, for example, in a rental return lot. Since the provider will know that the lot has sufficient coverage to provide a connection to the vehicle (or coverage could be provided by a LAN), the rental company will be able to generally ensure that the transaction can be handled seamlessly on their lot. The remainder of the Figures in 8A-8D deals with the cases where connectivity to a vehicle-installed modem is not available.

If there is no cellular modem, or if the cellular coverage does not currently exist for the modem to be connected, the process may have to take additional steps when a return is requested. For example, the rental end may not be allowed to occur until the user places the vehicle into park and keys off so that the vehicle may not be moved after the rental is considered ended. If there is a vehicle infotainment system 809, the process checks to see if cellular or WiFi coverage is available for that system to connect to the cloud 813. If there is no infotainment system, then the process will typically work off of a rolling code. The system can expire the current rolling code 811, and create a new rolling code when the next user arrives.

If the system has both an infotainment or telematics system and connectivity available 815 (i.e., the user has returned to an area with coverage, possibly a designated area), the user will put the vehicle in park and power off the ignition 817. The user then (if this has not already been done) indicates that the rental process should end 819. The vehicle system may use a variety of methods to receive the renter's intention to end the rental. As a non-limiting example, the user may enter his intention into vehicle HMI or a phone APP, or by placing a smart key into a LF backup pocket. A rental time may have passed, triggering the end process, or the user could, for example, manually initiate rental end.

The process then disables the keys and/or drive authorization for that user 821. This can be done, for example, by disabling a remote key, invalidating a code, or through any other means of deactivating whatever activation process was used to engage the vehicle.

In this example, the telematics system is connected to the cloud through a wireless phone, wirelessly connected to the vehicle system. The process transmits check-in/return notification through the connected phone 823. This can be done using the phone as a pass-through, or through an actual application running on the phone and communicating with both the vehicle and the cloud.

The process also, at this point, collects rental information 825, which can include, but is not limited to, total time of rental, location of vehicle, vehicle mileage and any other trip parameters the rental company wishes to gather. For example, any diagnostic warnings (low fuel, low tire pressure, etc.) could be sent, so the company knows the vehicle needs to be serviced before re-rental. A current fuel level could also be gathered and sent, if the renter is obligated to return the vehicle with a certain level of fuel. This information is then reported back to the cloud 827, for use by the rental company in various capacities.

Once the check-out procedure is complete, the user locks the vehicle and exits the vehicle, leaving the keys (if present) inside 829. Also, the vehicle could automatically lock after some brief time period once the user has exited, to ensure the vehicle is locked if in a remote location. The vehicle may also perform final key search and confirm that the key is left inside the vehicle for keys with that capability and report this information to the server. At this point, the rental ends and any charges can be processed 831.

If there is no cellular or WiFi (or other connectivity) available, the process may engage a vehicle key-pad if present 833. If there is a keypad on the vehicle, the vehicle can be returned to any location 835. Since the vehicle will not connect with the cloud upon rental-end, in this example, the user can return the vehicle to any location, whether or not coverage is present.

Again, the user will place the vehicle in park and key-off 837, then indicate that rental ending is desired 839. In this example, since there is no current connection to the cloud, a mobile device (e.g., a phone) will record the rental end process for later transmission 841. Since the vehicle still has functionality in the absence of connection, it will disable any appropriate keys as previously discussed 843.

In this example, the phone and/or vehicle will gather rental return information for later reporting 845. In some cases, the phone may gather the information for later reporting. In other examples, a vehicle computer may gather the information to be transmitted the next time the vehicle has connectivity. In at least one embodiment, a device connected to an On Board Databus (OBD) port can gather the device, and wirelessly communicate with the kiosk, for example. The user then locks the vehicle, leaving the keys inside if needed 847.

At some point, the phone or vehicle (depending on which source gathered the rental-end information) will re-enter a zone of connectivity and will be connected to the cloud 849. At this point, the gathered information can be reported 851. The rental will end, in this example, at either the vehicle recorded return time or the reporting time, depending on which scenario is desired by the vehicle owner and described by the rental agreement 853.

Even if a keypad is not present, there are possibilities for a user to return the vehicle to any location. If the user returns the vehicle to a location without coverage, in a telematics-equipped, no-keypad vehicle, after stopping the vehicle 855 and parking and powering down 857, the user can indicate a desire to end the rental 859.

Once again, the phone, or a vehicle telematics unit (or other suitable computer) can record the relevant rental end information 861 (such as end-time). The vehicle can disable all keys 863 and the vehicle or phone can collect all the additional information needed relating to the rental 865.

The user can then lock exit the vehicle. Here again, the vehicle may automatically lock after some brief time period once the user has exited, to ensure the vehicle is locked. The vehicle may also report to the user's phone that keys were left inside, a valid lock was performed and the vehicle is secured at the time of the renters departure. The user must then travel to an area with cellular or wife connectivity and connect his phone to report the ending rental conditions. At this point, the rental ends and any charges can be processed 831. The user may be credited for traveling time to connectivity at this point as well depending on the rental agreement terms. Again, if the vehicle did the recording, the reporting will be delayed until the vehicle re-enters connectivity (through a connected phone, for example). Once connectivity is re-established, the process will report the relevant information 871 and the rental process will end 873.

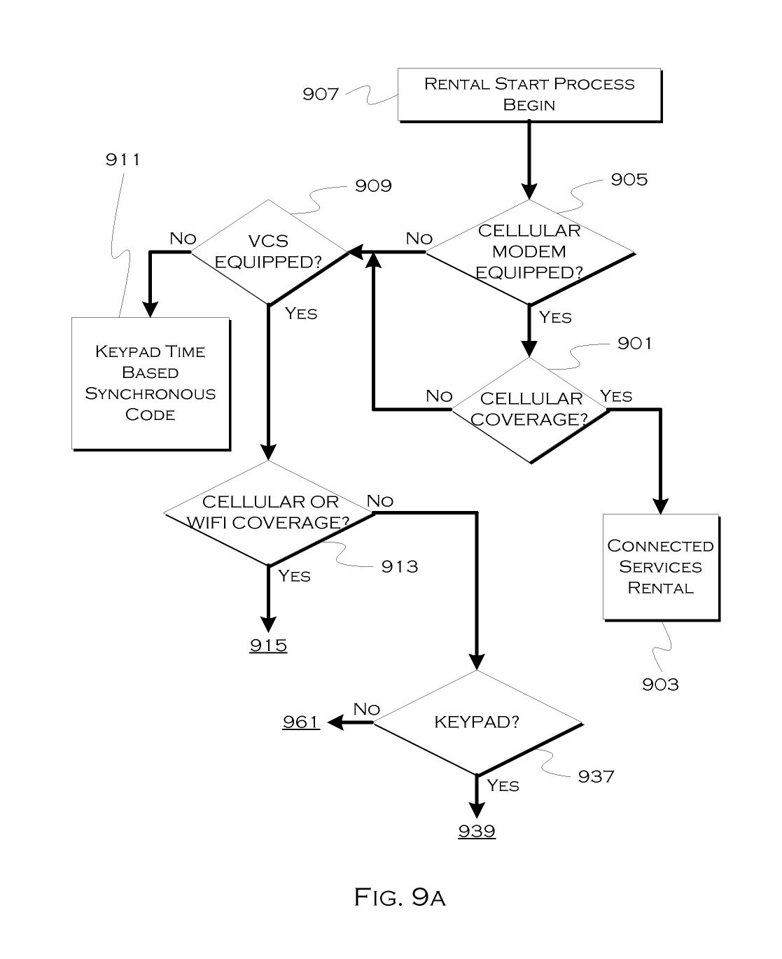

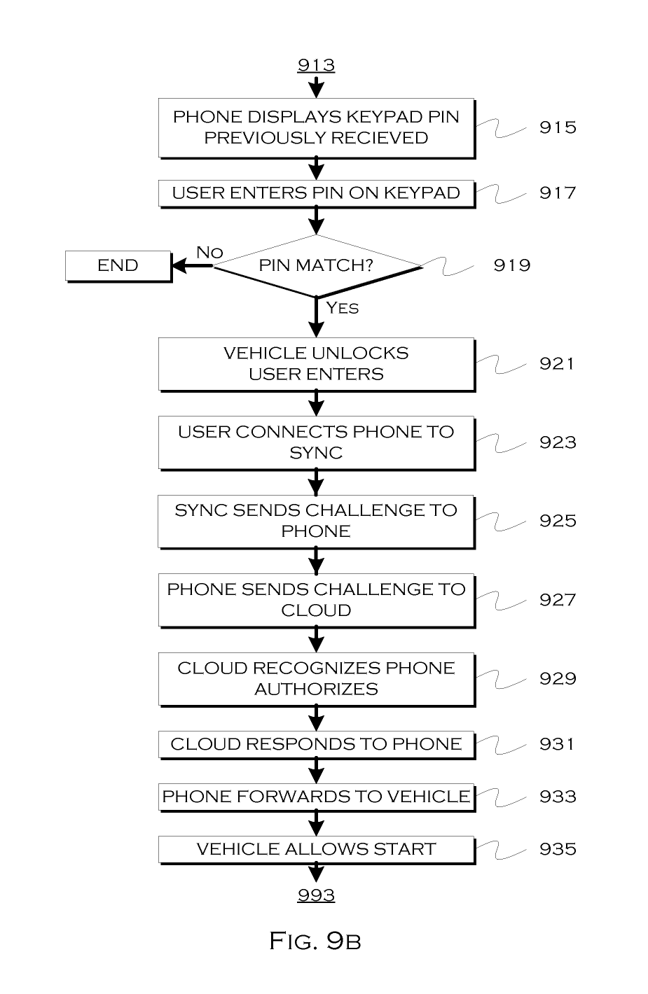

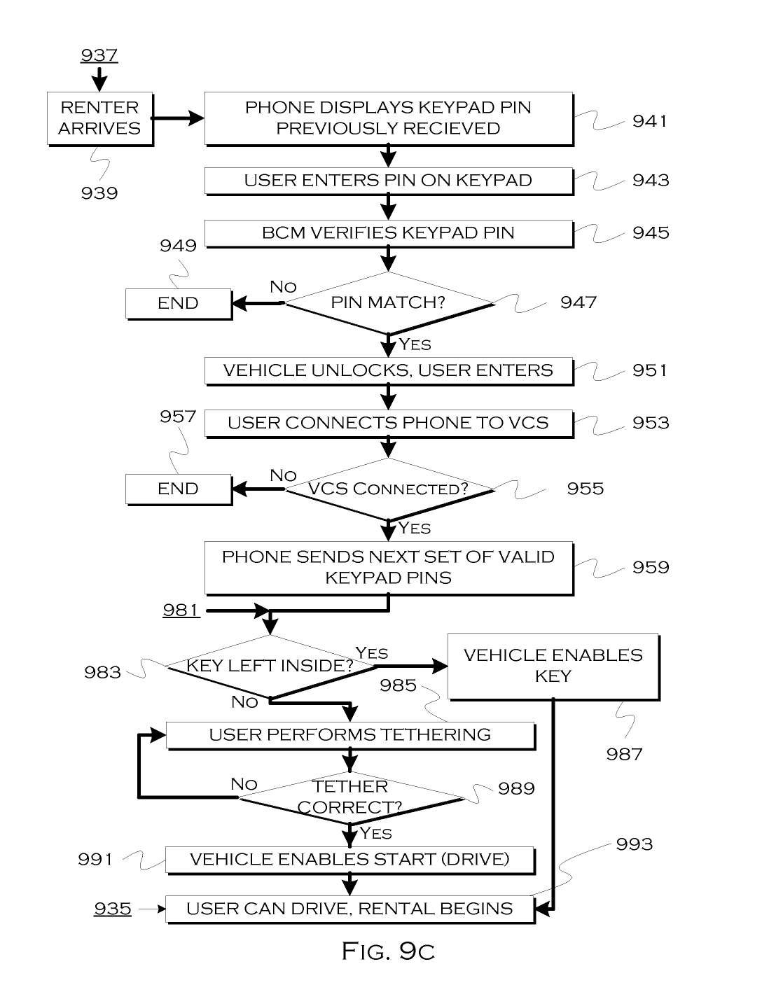

FIGS. 9A-9D show an illustrative example of a vehicle rental process. With respect to the illustrative embodiments described in these figures, it is noted that a general purpose processor may be temporarily enabled as a special purpose processor for the purpose of executing some or all of the exemplary methods shown herein. When executing code providing instructions to perform some or all steps of the methods, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, the user may rent a vehicle that has the following possible features: 1) in-vehicle modem (present/not present), in-vehicle telematics/infotainment computer (present/not present), access/startup keypad(s) (present/not present). This is just an illustrative example of vehicle choices, and the invention is not necessarily limited to vehicles having these options.

In this example, the process 907 checks to see if the vehicle is equipped with a modem 905. If there is a modem, and coverage exists 901, the process will use the connected vehicle computer in communication with the cloud to initiate the rental 903. Keys can be generated and activated, as well as codes transferred to a vehicle. Any and all enabling can be done on the spot, since the vehicle is connected and in communication with the cloud. Appropriate rental parameters (expirations, geofences, etc.) can also be set.

If there is no cellular coverage, or if there is no embedded modem present, the process checks for a telematics unit or infotainment system with connectivity options 909. If there is no such telematics unit, the process may utilize a rolling code for vehicle start 911. Rolling codes transform at a known interval into a known new code, so that two unconnected sources can generate the same next code and each source can recognize the validity/expiration of a given code based on the rolling code algorithm.

If there is cellular coverage for the telematics unit the process will instruct a phone to display a pin for input into a vehicle keypad (access keypad) 915. The user enters the pin 917 and the process checks for a match 919. In this example, the vehicle has also been provided with a copy of the pin, so that validity can be ensured. Entry of a correct pin unlocks the vehicle 921.

The user connects a phone to the telematics unit 923, which, in this example, uses a pre-approved phone to authorize vehicle start. The vehicle sends a challenge to the phone 925, which sends the challenge to the cloud 927.

Since the user, in this example, used a known phone to setup the rental and receive the entry pin, the cloud can recognize the phone 929 and authorize the phone. The cloud responds with the authorization 931, which is forwarded to the vehicle 933 and the vehicle can start 935.

If there is no cellular or WiFi coverage, the phone cannot be used to verify vehicle start, since the cloud is unavailable. In this example, the initial entry process is the same, the renter arrives 939, obtains a pin 941 (which was previously received, when coverage was available) and enters the pin 943 for verification 945.

If the pin matches a pin saved on the vehicle at a previous point (when coverage was available, during setup by the owner, initial manufacture or based on a rolling code, if rolling codes are used), the process unlocks the vehicle 951.

Since local connections can still be made, the phone can connect to the telematics unit 953. Once the phone is connected 955, the phone will securely send a set of key codes to the vehicle 959. These codes were initially received by the phone when the access code was received, previously stored by the vehicle and can be used to start the vehicle.

If a physical key is present in the vehicle 983, the vehicle can, upon receiving the valid code(s), enable the key 987.

If there is no key inside, the user can perform a tethering process 985, which, if correct, can enable vehicle start 989. The vehicle can then be started 991 and the rental can begin 993.

If there is no connectivity to the cloud, and no keypad for pin entry, the process can utilize BLUETOOTH or other recognition to allow vehicle access. When the renter arrives at the vehicle and touches the handle 961, the wireless system wakes up 963.

The renter will then open an application on the wireless device (e.g., phone) and the application will send BLUETOOTH pairing and a WiFi password to the vehicle 967 This will allow connection and pairing of the phone with the locked vehicle 969. Another non-limiting example of connection method that may be used here is NFC (Near Field Communication) or other similar short range wireless protocol.

Once a connection (local) is established, the process will send an encrypted packet 971, received when the rental was requested at a time when the phone had connectivity to the cloud. This packet will be decrypted by the vehicle 973. The packet may contain identifying information such as the Vehicle Identification Number (VIN) or serial number of various modules connected to the VCS. This information is specific to the target vehicle and will have been shared with the rental owner in the setup process. The packet can also contain various rental information usable to determine if access should be permitted. This can include, but is not limited to, renter number, date, time, command number or entry-event number, rental start and end time etc.

If the conditions for rental are met 977, the process can unlock the vehicle and allow entry 981. At this point, the process can enable startup as in the exterior keypad example shown in FIG. 9C.

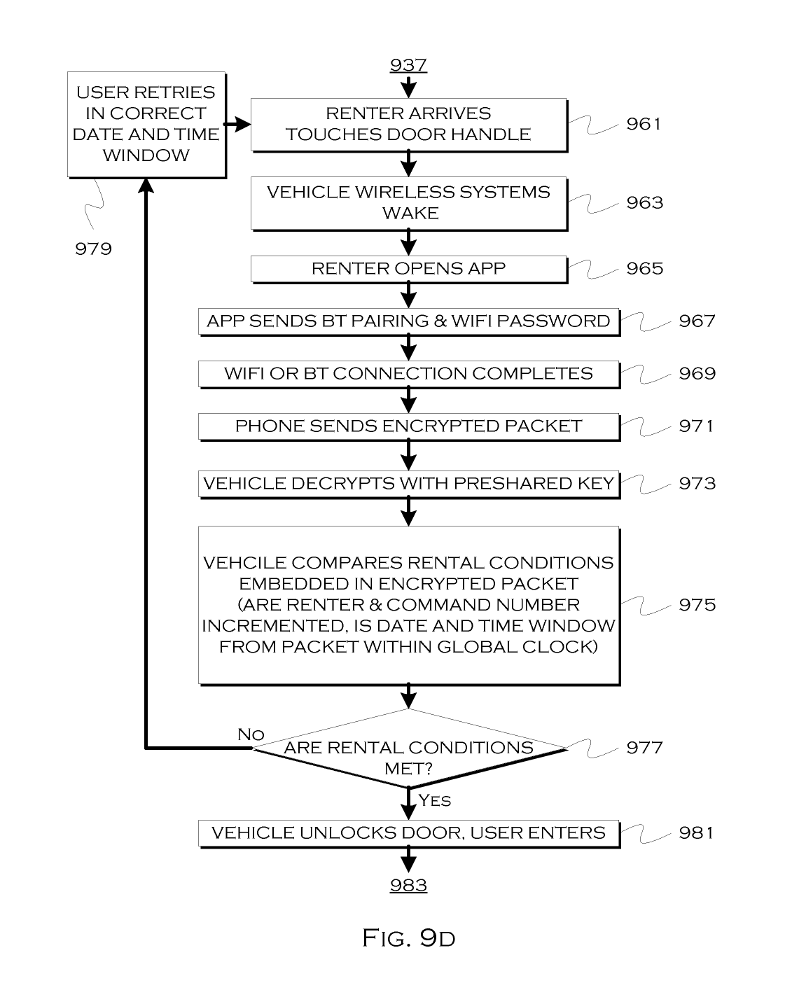

FIG. 10 shows an illustrative example of a kiosk rental begin-request process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In the illustrative embodiment shown in FIG. 10, the process is contemplated with respect to a rental kiosk installed at a rental pick up or drop off location. The kiosk may have both long range wireless (or wired) and short range wireless connectivity. The long-range connectivity may be used to access cloud-based resources, such as, but not limited to, servers holding user billing and reservation information, vehicle information, databases and any other useful cloud-stored information. The short range connectivity can be used to connect to, for example, without limitation, a user phone, a vehicle computing system, lot-based security systems and any other suitable local resources.

In the illustrative embodiment shown in FIG. 10, a process is running locally on a kiosk or remotely on the cloud with information exchange in the kiosk as needed. Further discussion of FIG. 10 will be with respect to an exemplary local process, provided for illustrative purposes only. In the illustrative example, a user who seeks to pick-up a rental vehicle approaches the kiosk and requests access to the reserved vehicle 1001. It is also possible to reserve and obtain a vehicle all in one step, if the kiosk is equipped with sufficient interface capability. In this example, however, billing information, driver information, etc., has been previously entered at an earlier time of reservation.

In this example, the user will identify themselves to the kiosk. This can be done in a variety of fashions, including, but not limited to, input of a reservation number, scanning of a credit card to be used with the rental (for deposit purposes, for example), scanning of a driver's license, near-field or other short-range communication with a phone, storing the appropriate information, input of a verification code, etc. Multiple forms of identification may be required in some instances to complete the reservation as well.

In one example, the user will be sent a verification code to input to identify the user to the kiosk. Then, for example, the kiosk may ask for credit card input and driver's license scanning, to the extent this information has not already been input. Even if the driver's license has been previously input, the system may want to scan the license again, to best ensure that the licensed driver is actually present at the location. While imperfect (since it may be difficult for the kiosk to compare the scanned license to the person standing at the kiosk), scanning of the license at least ensures that the party checking-out the vehicle likely has possession of the driver's license.

Once the user has been sufficiently identified 1003, the process will connect to a cloud-based reservation server 1005. In other examples not shown, reservation data may be periodically downloaded to the local kiosk on a daily, weekly, etc. basis, so that the connection to the server is not needed at the time of check-out. In this example, once the system has connected to the cloud-services, the process will ask for verification of a rental for the user 1007. Any upgrade options, insurance options, etc., can also be presented once the user has been verified as an authorized renter 1009.

If the process is unable to validate the user 1009, the kiosk can issue an error message and the user can attempt to resolve the issue. On the other hand, if the user is verified, the process can dispense the appropriate key 1013 corresponding to the requested vehicle. The keys/fobs can be identified through a variety of processes, including, but not limited to, physical partitioning for each key, NFC or BLUETOOTH identification of a particular key, barcode scanning of a code on a key, or any other suitable process. If the key/fob has any tracking mechanisms provided thereto (which will be discussed later with respect to vehicle check-in), the process can initialize the tracking for the particular key if needed, through short-range wireless communication with the key-fob, for example.

Once the key has been dispensed, in this example, it will only remain available for acquisition for a limited period of time. The key can be dispensed into a recoverable chamber where, if the key remains 1015 for a period of time longer than a timeout 1017 period, the key can be recovered (e.g., dropped through the bottom of the chamber back into the kiosk) 1019. This can help prevent a dispensed key from being overlooked, and a vehicle from being stolen. For example, if a customer does not realize the key has been dispensed, and is called away from the kiosk for some reason, it would not be desirable to have the key remain sitting in the kiosk for access by any passer-by. In other examples, if the customer breaks short range communication with the kiosk over a wireless link with a mobile device, this might be sufficient to trigger key recovery for any dispensed key, since this likely indicates that the customer has moved away from the kiosk.

The kiosk may also be provided with one or more physical connection capabilities, allowing for powering low-battery phones or communication over a wired, and thus more secure, connection. In such a case, breaking the wired connection may trigger the timeout countdown for key recovery, or, for example, may result in immediate key recovery.

Once the key is removed (in this example), dispensed, utilized, etc., the rental clock can begin 1021. To the extent that any data is collected from a vehicle while a rental is in progress, collection of the appropriate data can also begin at this time 1023. In some illustrative examples, a vehicle key-fob or user wireless device will wirelessly collect vehicle information while the rental is in progress. This information can be utilized to end the rental, and/or can be reported back to the rental agency at periodic intervals.

If an application on a mobile device or, for example, a vehicle key fob is utilized for tracking, the device may be instructed to begin tracking at or around the time a key/fob is dispensed. Through wireless communication with the vehicle, while the rental is in progress, the key/fob or mobile device can be used to record vehicle diagnostics, fuel levels, mileage and any other relevant information. This information can be reported remotely at periodic intervals, if remote connectivity to the cloud is available to the information collecting device, or, for example, it can be used at the time of vehicle return to report vehicle usage data. In still another example, a vehicle-installed processor, such as that in a vehicle computing system, a vehicle installed mobile device, or a vehicle installed device including data tracking capability, will communicate with the process to receive instructions to begin data track (and transmittal, if appropriate).

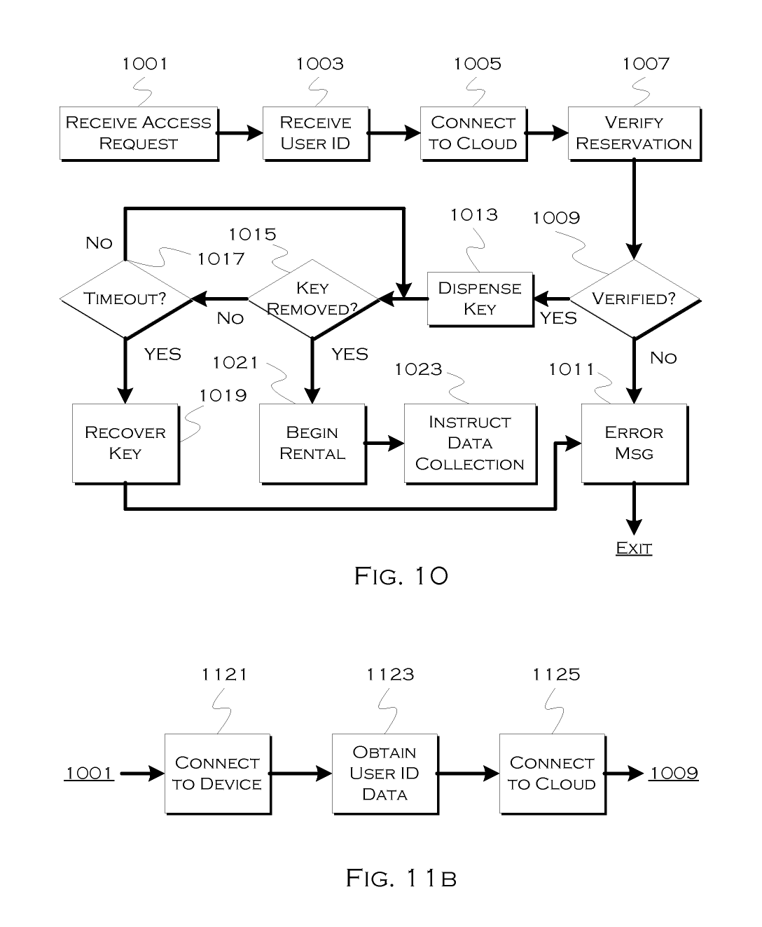

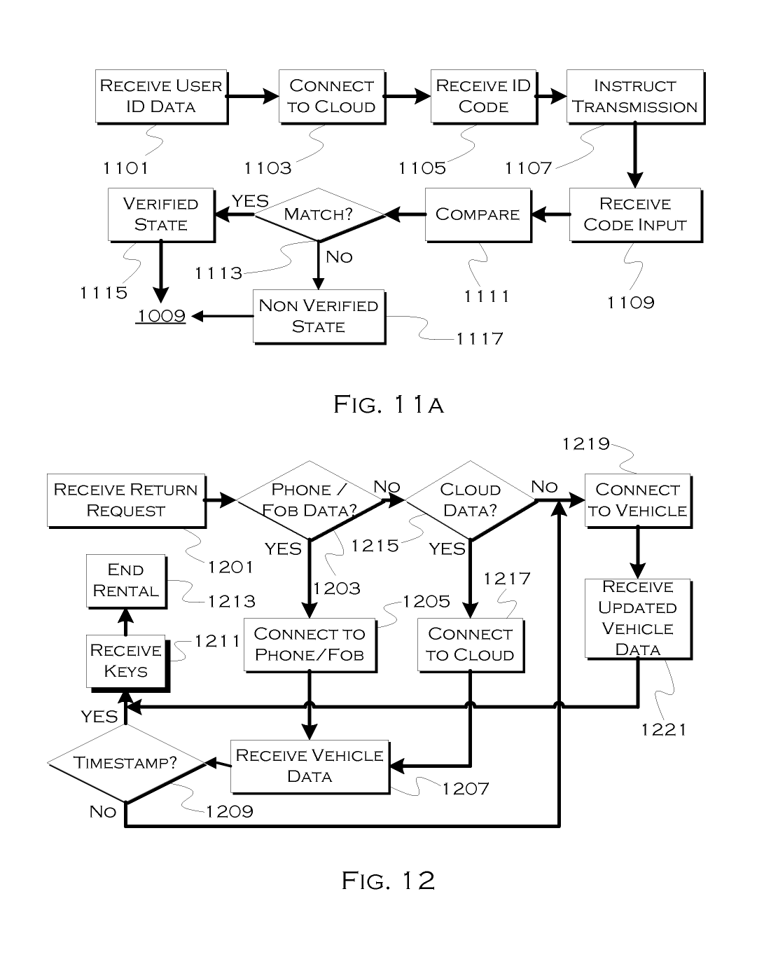

FIG. 11A shows an illustrative example of a verification process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

This process shows one non-limiting example of how user-verification may be performed. As previously noted, the verification can include verification of any and all information needed to complete the rental process. In this illustrative example, user identification data, for example, a driver's license or rental code, is input into the kiosk 1101. The kiosk then, in this embodiment, connects to a cloud-server for verification of the input identification. In this example, a further verification code will be received by both the user and the kiosk, to confirm that the appropriate party is attempting to begin the rental.

The kiosk receives one copy of the identification code 1105, and instructs transmission of the code to a user mobile device 1107. In other examples, the code may be automatically transmitted to an identified mobile device when the code is sent to the kiosk. In this example, the mobile device ID (for example, a phone number) is provided in advance, when the registration is made, so that there is further assurance that the device is one belonging to the appropriate user.

Once the code is received at the user mobile device, the code is input by the user 1109. By transmitting the code to both the kiosk and device at the time of rental, when the device is identified in advance, there is an additional layer of protection provided because the code cannot have been previously intercepted or accessed in the kiosk, and the mobile device usage confirms the same mobile device possessed by the user when the reservation was made is now receiving the code and is present at the kiosk.

The kiosk process then proceeds to compare the code input by the user to the code received from the server 1111. If there is a match 1113, the process can set a “verified” state that requires no further user verification 1115. By confirming the presence of the device, any additional verification can be bypassed and the user can proceed with the rental. If a “non-verified” state is set 1117, it can mean that either an incorrect code was input, or, for example, the user does not have the mobile device, that the mobile device is not powered, etc. In this example, the rental is not prohibited based on the non-verified state, but further verification may be required 1009. In this manner, the user is not prohibited from rental due to a lost phone, dead phone or other travel-related mishap that could affect the verification.

FIG. 11B shows a second illustrative example of a verification process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In this illustrative example, an application (used to make the reservation, for example) resides on a user device. Or, a user identification file or user identification information, at a minimum, has been provided to or is obtainable from a user device. As such, no physical user-input of data is required, and instead, the kiosk can connect to the device using some form of wireless communication or wired communication. The device is connected to in an appropriate manner (USB, NFC, WiFi, BLUETOOTH, etc.) by the kiosk 1121. Since the device or application running on the device was previously provided the authentication information, the user need not take any additional steps other that mere possession of the device in this example. Of course, additional verification may be required as appropriate.

User identification data is obtained 1123 from the device once the kiosk has connected to the device 1121. Using this information, the process can connect to the cloud server 1125 and upload the information for verification, or, in another example, download verification information for comparison to information already in the kiosk (received from the device). Some combination of the two verification processes may also be utilized, with additional steps being added or steps being omitted as appropriate for the desired verification paradigm.

In still another identification paradigm, a QR code, barcode or similar scannable code may be provided to the user device at some point prior to removal of the key. By presenting this information to a scanner on the kiosk, the appropriate information contained in the scannable code can be verified and the key can be dispensed (after any needed additional information is transmitted).

FIG. 12 shows an illustrative example of a kiosk rental end-request process. With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

In the illustrative example, the vehicle kiosk is capable of retrieving some form of rental-end information when the vehicle is returned. In this example, the process can receive data from a phone or a fob, from the server and, if needed, directly from a vehicle itself. In other examples, the vehicle may be returned via the kiosk and any check-in type information may need to be manually input into any system, as appropriate.

In this example, the process (running in the kiosk or on a server connected to the kiosk) receives a request to return a vehicle 1201. By utilizing this process, rental returns are possible at all hours of the day and night, without necessarily having to have on-site personnel present to check-in a vehicle. In this example, the process checks to see if a mobile device or vehicle key fob is attempting to report data 1203, or is assigned to have stored/retrieved data thereon. If there is no local data available or supposed to be available from a phone or a fob, the process checks to see if there are instructions to receive usage data from the cloud 1215. For example, a vehicle may report data to the cloud, while a rental is in progress, and thus the end-data can be retrieved based on the cloud-reporting. Finally, if there is no cloud-retrieval of data scheduled, the process can connect directly to the vehicle (through, for example, wireless communication) 1219. If no connection to the vehicle is available, the process can skip the data collection steps at return time and complete the data exchange at a later time. This would still allow the user to return the keys in a timely manner, however.

If the data is to be retrieved from the phone or from a fob, the process connects, in a wired or wireless manner, to the mobile device (phone, tablet, etc.) or the key fob 1205. Similarly, if vehicle data is to be retrieved from the cloud, the process can use wired or wireless communication to connect to a cloud server 1217. Once the appropriate connection has been established, the process can retrieve data from the mobile device, fob or cloud 1207. This is typically the data received at the end of a rental inspection, and can include, but is not limited to, diagnostic data, fuel levels, odometer readings and even pictures from vehicle interior cameras and other sensors, if desired.

In many instances, the updated data on the fob, mobile device or cloud may not represent an immediate snapshot of the last second before the vehicle was returned. To this end, a timestamp is also included with the data. If the timestamp is not proximate enough in time to the immediate time 1209 (typically, within a threshold range), the process will directly connect to the vehicle 1219 to receive a final update of data 1221. This is the same data, or some subset of the data, that would be received if the cloud-based or local fob/device data were not present. Once any additional needed data is retrieved, or if the timestamp indicates no additional data is needed, the process will receive the keys in a receiving unit 1211, which allows the keys to be stored safely in an interior of the kiosk. At this time, once the data and keys have been received, the rental process can be ended 1213.

In at least one embodiment, the key is provided with an identifier that is readable by a kiosk system. To facilitate quick return, the user can merely drop the key into the kiosk and be on their way. The local system in the kiosk can scan the key (through a wireless connection, for example, such as, but not limited to, BLUETOOTH or NFC; or, for example, through a barcode scan, or other suitable identification process) and retrieve any information in, for example, the exemplary manners described above. A report on the vehicle can be generated and sent to a renter's cell phone, confirming the rental completion information. In still a further example, the system may attempt to verify the presence of the vehicle (using, for example, lot cameras, a local wireless connection to a vehicle computer or other wireless identification device installed in the vehicle; or other appropriate means of identification) prior to telling the user the rental is complete.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive rental return information;
verify deposit of a key fob;
connect to a device containing vehicle usage information relating to a rental period;
gather vehicle usage information from the device;
verify a vehicle presence in a rental parking lot; and
terminate a vehicle rental.

2. The system of claim 1, wherein the rental return information includes a rental contract identification obtained through identification of the deposited key fob.

3. The system of claim 1, wherein the rental return information is user-input.

4. The system of claim 1, wherein the device containing vehicle usage information includes the key fob.

5. The system of claim 1, wherein the device containing vehicle usage information includes a driver mobile device.

6. The system of claim 1, wherein the device containing vehicle usage information includes a vehicle computing system.

7. The system of claim 1, wherein the processor is configured to verify the vehicle presence through wireless communication with the vehicle.

8. The system of claim 1, wherein the processor is configured to verify the vehicle presence through communication with a vehicle lot camera.

9. The system of claim 1, wherein the processor is configured to verify the vehicle presence through wireless communication with a wireless identification device installed in the vehicle.

10. A system comprising:
a processor configured to:
receive rental information from a user mobile device;
verify the received rental information; and
dispense a vehicle activation device in accordance with the received rental information.

11. The system of claim 10, wherein the processor is further configured to instruct a vehicle data gathering process executing on an onboard data bus (ODB) connected device to begin gathering vehicle data when a vehicle is started using the vehicle activation device.

12. The system of claim 10, wherein the processor is configured to instruct a vehicle data gathering process executing on the user mobile device to begin gathering vehicle data when a vehicle is started using the vehicle activation device.

13. The system of claim 10, wherein the processor is configured to instruct a vehicle data gathering process executing on a processor provided as part of the activation device to begin gathering vehicle data when a vehicle is started using the vehicle activation device.

14. The system of claim 10, wherein the processor is configured to instruct a vehicle data gathering process executing on a vehicle-installed processor to begin gathering vehicle data when a vehicle is started using the vehicle activation device.

15. The system of claim 10, wherein the processor is configured to communicate wirelessly with the user mobile device to receive the rental information.

16. The system of claim 10, wherein the processor is configured to communicate physically with the user mobile device to receive the rental information.

17. The system of claim 16, wherein the processor is configured to utilize an optical sensor provided to the processor to scan information from the mobile device to receive the rental identification information.

18. The system of claim 16, wherein the processor is configured to utilize a wired connection with the mobile device to receive the rental identification information.

19. A computer-implemented method comprising:
receiving rental information from a user mobile device;
verifying the received rental information using a kiosk-based processor; and
dispensing a vehicle activation device in accordance with the received rental information.

20. The method of claim 19, further comprising instructing a vehicle data gathering process executing on a remote device to begin gathering vehicle data when a vehicle is started using the dispensed activation device.
